(19) United States
(12) Patent Application Publication
(10) Pub. No.: US 2003/0219518 A1
(43) Pub. Date: Nov. 27, 2003

(54) Process and apparatus for reducing residual level of acrylamide in heat processed food

(76) Inventor: Zhaoaying Li, Norcross, GA (US)

Correspondence Address: Zhaoyang Li,, 4403 Fielding Lane, Norcross, GA, 30092, US

(21) Appl. No.: 10/152,270

(22) Filed: May 21, 2002

(51) Int. Cl. A23L 1/00

(52) U.S. Cl. 426/478

(57) ABSTRACT

Methods and apparatuses are provided herein for reducing the level of acrylamide in heat-processed or cooked starchy food to a safe level. The methods and apparatuses described herein generally involve applying a vacuum to the starchy food and/or applying a light radiation to the starchy food. The starchy food can be flushed with a stream of gas such as air, oxygen, nitrogen, carbon dioxide, ozone, or a combination thereof. The starchy food can be heated at a temperature between the ambient temperature to about the boiling point of acrylamide.

### BACKGROUND OF THE INVENTION

The process and apparatus disclosed herein are generally related to method for food processing. More particularly, the process and apparatus disclosed herein are related to method for reducing residual level of acrylamide in heat processed starchy food.

Acrylamide is an odorless and colorless solid that has a melting point at about 87° C. and a boiling point at about 125° C. Acrylamide is a monomer that can polymerize into poly(acrylamide), a chemical that is manufactured for use in water treatment, paper and pulp production. Acrylamide is known to be carcinogenic in rats and laboratory animals at certain exposure levels. Research papers of the National Health Services indicate that prolonged exposure to high levels of acrylamide may be associated with increased occurrences of cancers among workers employed at water treatment plants and paper/pulp plants. Such risks have been known at OSHA since the 1980s. Acrylamide is highly water-soluble and is taken up through breaks in the skin, through ingestion of liquids and may be inhaled. Information regarding acrylamide and safety issues related thereto can be found at: http://ntpserver.niehs.nhs.gov/htdocs/8RoC/RAC/Acrylamide.html.

On April 24, Leif Burk, research director of the Swedish National Food Administration issued a press release with respect to research in progress at Stockholm University's Department of Environmental Chemistry in which Professor Margareta Tornquist is involved. The press release announced that measurements had been made of Burger King and McDonalds' French fries, purchased from local retail outlets, that disclosed the presence of significant amounts of acrylamide. The research indicated that subjecting any starchy foods to high heat for prolonged periods, such as occur in roasting, baking, frying and grilling of potatoes (and cereals and breads) cause acrylamide to be produced. About two weeks later, in early May, the British Food Standards Administration announced corroborative findings, noting that its own testing of fourteen popular starchy processed food products sold in Britain disclosed significant doses of acrylamides. These products included “Pringles” and “Kellogg's Special K” cereal.

The challenge for removing acrylamide from heat-processed food is that the heat-processed starchy food cannot be subject to chemical process or physical processes that would destroy the food texture. For example, acrylamide is highly soluble in water. But using water to dissolve acrylamide in the cooked food is simply unacceptable to consumers.

Therefore, there is a need for processes and apparatuses to remove acrylamide from cooked or heat-processed food that do not substantially change the texture and taste of the food.

It is therefore an object of the present invention to provide a process and apparatus that can remove acrylamide or destroy acrylamide monomer that do not substantially change the texture and taste of the food.

### SUMMARY OF THE INVENTION

The process and apparatus disclosed herein provide a method to reduce acrylamide level in heat-processed or cooked food. The process generally involves subjecting to the starchy food to a vacuum, light, or a combination thereof In one embodiment, the heat-processed or cooked food is placed in a vacuum, thereby removing the acrylamide monomer. Optionally, in addition to vacuum, the food can be subjected to heating at a temperature ranging from 0° C. to about 125° C., preferably from ambient temperature to about 125° C., most preferably from about 87° C. to about 125° C.

In another embodiment, the heat-processed or cooked food is subject to light radiation. Upon light radiation, acrylamide readily polymerizes to form poly(acrylamide) which is not only non-toxic, but also no longer carcinogenic. The light radiation process can be combined with the vacuum process, optionally with heating at a temperature ranging from 0° C. to about 125° C., preferably from ambient temperature to about 125° C., most preferably from about 87° C. to about 125° C.

Apparatus effecting the process disclosed herein includes a container that provides storage for the food, and an outlet connected to a vacuum line. Optionally, the apparatus has an inlet for gas to flush the food stored therein, and/or a light source that provides light for radiation of the food, and/or a heater that can heat the food, and/or a door or opening for removal of food in which acrylamide monomer level is reduced.

In another embodiment, the apparatus disclosed herein contains a container that provides storage for the food, and a light source that provides light radiation. Optionally, the apparatus has an outlet connected to a vacuum line, and/or an inlet for gas to flush the food stored therein, and/or a heater that can heat the food, and/or a door or opening for removal of food in which acrylamide monomer level is reduced.

### BRIEF DESCRIPTION OF THE DRAWINGS

FIG. 1 shows a representative apparatus for removing acrylamide from the heat-processed or cooked starchy food by vacuum.

### DETAILED DESCRIPTION OF THE INVENTION

I. Definition

1. The term “starchy food” as used herein refers to any agriculture product that has starch content or any meat food that has any content of starch. Representative starchy food includes potato or potato products, corn or corn products, rice or rice products, wheat and wheat products, and meat products that have any starch content. Exemplary potato products includes French fries, potato chips, and other products made of potato. Exemplary wheat products include bread, cake, cereal, and any other products made of wheat or flour. Exemplary meat products having starch content include Hamburger, Kentucky Fried Chicken, and any other meat products that have starch-content.

The term “heat-processed” or “cooked” as used herein refers to a process involving substantial heating. The process includes, for example, roasting, baking, frying, steaming, and boiling.

The term “light radiation” as used herein refers to radiation of the starchy food by light. As used herein, “light” can have various wave-length, for example, from infrared light, visible light, ultraviolet, x-ray, to gamma radiation.

II. Method for Reducing Acrylamide Level

A. Polymerizaiton of Acrylamide

Acrylamide is an electronically-unsaturated chemical having the formula: CH₂═CHCONH₂. Acrylamide readily polymerizes upon exposure to heat or radical generating agents to form poly(acrylamide). Poly(acrylamide) is a nontoxic chemical that has broad application in water treatment, paper and pulp industry. Poly(acrylamide) has been widely used in pharmaceutical industry as an ingredient in drug formulations. Moreover, poly(acrylamide) is also widely used in biotechnology, for example, in tissue engineering.

Acrylamide in heat-processed or cooked starchy food can be polymerized into poly(acrylamide) by radiation of the food with light. Upon exposure to light, the carbon-carbon double bond in the acrylamide molecule is broken to form a radical which readily polymerizes into harmless poly(acrylamide), thereby reducing the level of acrylamide in the starchy food to the level as set by in, for example, World Health Organization's Food Safety Programme (see, for example, http://www.who.int/en/pr-2002.32.html). A general guideline for the allowable residual acrylamide level in the starchy food is that the overall amount of acrylamide in the total volume of starchy food to be consumed by one person in one day shall not exceed the maximum daily exposure level set by the World Health Organization for drinking water.

The light used herein can be infrared light, visible light, ultraviolet, x-ray, or gamma radiation. In one embodiment, the light is visible light. In another embodiment, the light is ultraviolet. In still another embodiment, the light is infrared light.

The light radiation process can be combined with the vacuum process, optionally with heating at a temperature ranging from 0° C. to about 125° C., preferably from ambient temperature to about 125° C., most preferably from about 87° C. to about 125° C.

A general guideline for the allowable residual acrylamide level in the starchy food is that the overall amount of acrylamide in the total volume of starchy food to be consumed by one person in one day shall not exceed the maximum daily exposure level set by the World Health Organization for drinking water.

B. Vacuum Treatment

Vacuum treatment is anther convenient method for removing acrylamide The molecule has a structure in which the two methylene carbons, oxygen, and nitrogen atoms form a four atom π-stack structure. This structure dramatically reduces the strength of any hydrogen-bonding that may exist in the molecule or between the molecule and other chemicals. This feature allows one to remove residual acrylate from heated-processed or cooked starchy food.

Acrylamide has a melting point at about 87° C. and a boiling point at about 125° C. As such, acrylamide can be readily removed by vacuum. For vacuum treatment, the starchy food preferably has low moisture content. Exemplary starchy foods suitable for vacuum treatment include, for example, potato chips, cereal, and fried flour products such as PREZEL™. Various mechanical or oil-pumps that provide sufficient vacuum are readily available in art. Generally, the method disclosed herein involves the subjecting starchy food to a vacuum, thereby reducing the acrylamide level in the starchy food to the level as set by in, for example, World Health Organization's Food Safety Programme (see, for example, http://www.who.int/en/pr-2002.32.html). A general guideline for the allowable residual acrylamide level in the starchy food is that the overall amount of acrylamide in the total volume of starchy food to be consumed by one person in one day shall not exceed the maximum daily exposure level set by the World Health Organization for drinking water.

The vacuum treatment method can be used in combination with the light radiation process and/or heating at a temperature ranging from 0° C. to about 125° C., preferably from ambient temperature to about 125° C., most preferably from about 87° C. to about 125° C. Additionally, the vacuum treatment method can be used in combination with gas-flushing. For example, the vacuum can be broken by a stream of gas. The starchy food is then flush with the gas. The gas can be a stream of air, nitrogen, carbon dioxide, oxygen, ozone, or mixtures thereof The vacuum is then reapplied to the starchy food. The vacuum-gas flushing cycle can be repeated so as to remove residual acrylamide to a safe level.

C. Ozone Treatment

The characteristics of the chemical structure of acrylamide open another door or opening for reducing acrylamide from starchy food. Ozone is a gaseous matter that has been widely used in medical industry to deodorize a substance or to kill bacteria. Ozone is highly oxidative and can react with the C═C bond in acrylamide to form harmless molecules such as formic acid. Un-reacted ozone can be readily removed by vacuum.

The ozone treatment process is preferably used in combination with the vacuum treatment process. Optionally, the ozone treatment process can be used with the vacuum treatment process and the light radiation process.

When ozone is used to degrade acrylamide, the ozone should be allowed to contact with the starchy food for a sufficient period of time, for example, 5 minutes to several days. Generally, starchy food with sufficient moisture content, i.e., French fries, can be treated with ozone for a period that is relatively short, e.g., 5 minutes to one hour, preferably 10 minutes to one hour, most preferably 30 minutes to one hour. Starchy foods that are substantially free of moisture content can be treated with ozone for a longer period of time, e.g., from one hour to 2 days, preferably two hours to 10 hours, most preferably 5 hours to 10 hours.

III. Apparatus for Reducing Acrylamide Level

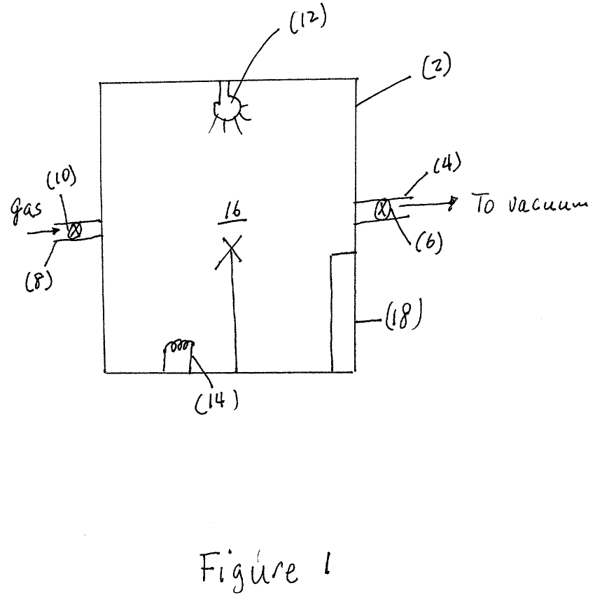

As FIG. 1 shows, the apparatus embodying the method disclosed herein generally includes a container (2) that provides storage for the food, and an outlet (4) that has a valve (6) for connection to a vacuum line. Optionally, the apparatus has an inlet (8) that has a valve (10) for introducing gas to flush the food stored therein, and/or a light source (12) that provides light for radiation of the food, and/or a heater (14) that can heat the food, and/or a stirrer (16) to provide stirring of the starchy food, and/or a door or opening (18) for adding or removing the food in which acrylamide monomer level is reduced.

In another embodiment, the apparatus disclosed herein includes a container (2) that provides storage for the food, and a light source (12) that provides light radiation, an outlet (4) that has a valve (6) connected to a vacuum line. Optionally, the apparatus has an inlet (8) that has a valve (10) for introducing gas to flush the food stored therein, and/or a heater (14) that can heat the food, and/or a stirrer (16) to provide stirring of the starchy food, and/or a door or opening (18) for adding or removing the food in which acrylamide monomer level is reduced.

The following non-limiting examples further illustrate the method and apparatus disclosed herein.

### PROPHET EXAMPLES

### Example 1

Removing Acrylamide in Potato Chips by Vacuum Treatment

Potato chips are purchased from grocery stores and are placed in the apparatus shown in FIG. 1. The apparatus is then heated at 85° C. A vacuum of 0.01 torr is applied to the apparatus for, i.e., one hour. The vacuum-light treated potato chips have a reduced level of acrylamide as compared to the acrylamide level prior to treatment.

### Example 2

Removing Acrylamide in Potato Chips by Vacuum Treatment in Combination of Light Radiation

Potato chips are purchased from grocery stores and are placed in the apparatus shown in FIG. 1. The apparatus is then heated at 85° C. A vacuum of 0.01 torr is applied to the apparatus for, i.e., one hour. An ultralight is then turned on to provide the starchy food with radiation for, i.e., 30 minutes. The vacuum-light treated potato chips have a reduced level of acrylamide as compared to the acrylamide level prior to treatment.

### Example 3

Removing Acrylamide in Potato Chips by Vacuum Treatment and Light Radiation in Combination with Gas-Flushing

Potato chips are purchased from grocery stores and are placed in the apparatus shown in FIG. 1. The apparatus is then heated at 85° C. A vacuum of 0.01 torr is applied to the apparatus for, i.e., 10 minutes. A stream of air is then introduced. The vacuum of 0.01 torr is then reapplied for, i.e., 10 minutes. An ultralight is then turned on to provide the starchy food with radiation for, i.e., 30 minutes. The vacuum-light treated potato chips have a reduced level of acrylamide as compared to the acrylamide level prior to treatment.

Those skilled in the art will recognize, or be able to ascertain using no more than routine experimentation, many equivalents to the specific embodiments of the invention described herein. Such equivalents are intended to be encompassed by the following claims.

We claim:

1. A method of reducing acrylamide level in a cooked or heat-processed starchy food comprising:
applying a vacuum to the starchy food.

2. The method of claim 1 further comprising
heating the starchy food to a temperature between ambient temperature to the boiling point of acrylamide.

3. The method of claim 1 further comprising:
radiating the starchy food with light.

4. The method of claim 1 further comprising
flushing the starchy food with a gas.

5. The method of claim 2 further comprising flushing the starchy food with a gas.

6. The method of claim 3 wherein the light is selected from the group consisting of infrared light, visible light, ultraviolet light, x-ray, or gamma radiation.

7. The method of claim 4 wherein the gas is ozone.

8. The method of claim 5 wherein the gas is ozone.

9. A method of reducing acrylamide level in a cooked or heat-processed starchy food comprising:
applying a light radiation to the starchy food.

10. The method of claim 9 further comprising
heating the starchy food to a temperature between ambient temperature to the boiling point of acrylamide.

11. The method of claim 9 further comprising
flushing the starchy food with a gas selected from the group consisting of air, oxygen, nitrogen, carbon dioxide, and mixtures thereof.

12. The method of claim 10 further comprising flushing the starchy food with a gas selected from the group consisting of air, oxygen, nitrogen, carbon dioxide, and mixtures thereof.

13. The method of claim 9 wherein the light is selected from the group consisting of infrared light, visible light, ultraviolet light, x-ray, or gamma radiation.

14. An apparatus comprises:
a container (2) that provides storage for the food, and
an outlet (4) that has a valve (6) for connection to a vacuum line or
a light source (12) that provides light for radiation of the food.

15. The apparatus of claim 14 further comprising:
an inlet (8) that has a valve (10) for introducing a gas to flush the food stored therein.

16. The apparatus of claim 14 further comprising
a heater (14) that can heat the food, and/or a stirrer (16) to provide stirring of the starchy food.

17. The apparatus of claim 15 further comprising
a heater (14) that can heat the food, and/or a stirrer (16) to provide stirring of the starchy food.

18. The apparatus of claim 16 further comprising
a stirrer (16) to provide stirring of the starchy food.

19. The apparatus of claim 17 further comprising
a stirrer (16) to provide stirring of the starchy food.
